(19) United States
(12) Patent Application Publication
(10) Pub. No.: US 2002/0015854 A1
(43) Pub. Date: Feb. 7, 2002

(54) Paper coating composition comprising a blend of modified high amylose starch and polyvinyl alcohol

(76) Inventors: Robert L. Billmers, Stockton, NJ (US); Victor L. Mackewicz, Califon, NJ (US)

Correspondence Address: Eugene Zagarella Jr, National Starch and Chemical Company, Box 6500, Bridgewater, NJ, 08807-0500, US

(21) Appl. No.: 09/568,111

(22) Filed: May 10, 2000

(51) Int. Cl. B32B 27/00

(52) U.S. Cl. 428/500

(57) ABSTRACT

A paper coating composition providing good barrier properties comprising a blend of hydrophobically modified high amylose starch and polyvinyl alcohol.

### BACKGROUND OF THE INVENTION

This invention relates to a paper coating and surface sizing composition that provides good barrier properties when applied to paper and comprises a blend of hydrophobically modified high amylose starch and polyvinyl alcohol.

Barrier properties which are provided to paper by effective coating compositions include porosity reduction to air, water resistance, increased oil and grease resistance and higher surface strength.

Coating and surface sizing of paper have been used to provide beneficial attributes to paper including paper strength, retarding liquid penetration into the sheet and the quality and ease of printing on the paper. Various materials and compositions have been used to coat and size paper including starch and polyvinyl alcohol which have been used as components in different coating compositions. As illustrated in U.S. Pat. No. 4,278,583 issued on Jul. 14, 1981 to M. Sekiya; U.S. Pat. No. 4,837,087 issued on Jun. 6, 1989 to Floyd et al; and U.S. Pat. No. 5,292,781 issued to W. Floyd on Mar. 8, 1994, starch and polyvinyl alcohol are used as binders in paper coating compositions.

U.S. Pat. No. 4,758,279 issued to M. Hasuly et al on Jul. 19,1988 discloses the use of hydrophobic starch derivatives and polyvinyl alcohol in textile warp sizing compositions to strengthen and protect the yarn and uniformly distribute the lubricant.

While the use of various materials in paper coating compositions has been disclosed as noted above, there is still the need and desire for a coating composition that will provide highly effective barrier properties when applied to paper.

### SUMMARY OF THE INVENTION

Now in accordance with this invention, a paper coating composition that is a selected blend of hydrophobically modified high amylose starch and polyvinyl alcohol, provides paper products with especially good barrier properties.

More particularly, this invention relates to a paper coating composition that provides good barrier properties and comprises:

a) a hydrophobically modified high amylose starch wherein the starch base material is starch having an amylose content of at least 40% by weight and the starch is modified with a hydrocarbon group of 6 to 18 carbon atoms, and

b) from about I to 10% by weight based on the weight of dry starch, of polyvinyl alcohol having a degree of hydrolysis of from about 88 to 99%.

### DETAILED DESCRIPTION OF THE INVENTION

This invention involves a coating composition for paper that provides exceptionally good barrier properties for the coated paper. The term ‘coating’ composition as used herein, refers to both a coating and surface sizing composition for paper. Barrier properties refer to an increase in the resistance of paper to various materials such as water, air, oil and grease, and also higher surface strength (wax pick) and resistance to crack-on-fold.

The coating composition of this invention comprises a selected blend or combination of hydrophobically modified high amylose starch and polyvinyl alcohol. The starch is hydrophobically modified with hydrocarbon groups of at least 6 carbon atoms, more particularly 6 to 18 and preferably 8 to 12 carbon atoms. This hydrophobically modified starch can be prepared by reacting starch and an organic anhydride reagent and has the following formula:

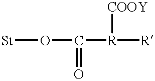

where St is the high amylose starch base material, R is a dimethylene or trimethylene group, R′ is a hydrocarbon group of 6 to 18 and preferably 8 to 12 carbons and Y is H, alkali metal, alkaline earth metal or ammonium. The hydrocarbon or hydrophobic substituent group R′ may be alkyl, alkenyl, aryl, aralkyl or aralkenyl, preferably alkyl or alkenyl and more preferably alkenyl. The amount of the derivative group bound to the starch, i.e.,

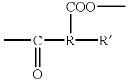

will be from about 1 to 5% and preferably from about 2 to 3% by weight, based on the weight of dry starch.

The starch material used as the starting base material in this invention will be a high amylose starch, i.e. one containing at least 40% by weight of amylose. It is well known that starch is composed of two fractions, the molecular arrangement of one being predominantly linear and the other being highly branched. The linear fraction of starch is known as amylose and the branched fraction amylopectin. Starches from different sources, e.g. potato, corn, tapioca and rice, etc., are characterized by different relative proportions of amylose and amylopectin components. Some plant species have been genetically engineered or modified by classical hybrid breeding and are characterized by a large preponderance of one fraction over the other. For instance, certain varieties of corn which normally contain 22-28% amylose have been developed which yield starch composed of over 40% amylose. These hybrid varieties have been referred to as high amylose or amylomaize.

High amylose corn hybrids were developed in order to naturally provide starches of high amylose content and have been available commercially since 1963. Suitable high amylose starches useful herein are any starches with an amylose content of at least 40% and preferably at least 65% by weight. While high amylose corn starch is especially suitable, other starches which are useful include those derived from any plant species which produces or can be made to produce a high amylose content starch, e.g. corn, peas barley and rice. Additionally, high amylose starch can be obtained by separation or isolation such as the fractionation of a native starch material or by blending isolated amylose with a native starch.

The modified high amylose starch may be further modified or derivatized to contain other groups in addition to the hydrocarbon chain as long as such groups do not interfere with the barrier or film forming properties provided by the hydrocarbon substituent and the starch itself. Usually these modifications are accomplished or provided prior to the modification with the hydrophobic or hydrocarbon group. Thus, the base starch may include any of several starches, native, converted or derivatized as long as the required high amylose content is present. Such starches include the conversion products derived from any of the former bases such as, for example, dextrins prepared by hydrolytic action of acid and/or heat; fluidity or thin boiling starches prepared by enzyme conversion, catalytic conversion or mild acid hydrolysis; oxidized starches prepared by treatment with oxidants such as sodium hypochlorite; and derivatized or modified starches such as cationic, anionic, amphoteric, non-ionic and crosslinked starches. Additionally, functional starches which contain carboxyl or phosphate groups obtained from natural sources can be utilized.

The preparation of the hydrophobic starch derivative can be carried out by known procedures. One such method is disclosed in U.S. Pat. No. 2,661,349 issued on Dec. 1,1953 to C. Caldwell et al. which describes hydrophobic starch derivatives such as starch alkyl or alkenyl succinates. This '349 patent describes an aqueous method in which such derivatives are prepared using a standard esterification reaction where the anhydride reagent and starch are suspended in water and mixed under alkaline conditions. Another method for preparing the hydrophobic starch derivatives is disclosed in U.S. Pat. No. 5,672,699 issued on Sep. 30, 1997 to R. Bilmers et al. This patent describes a method for preparing hydrophobic starch derivatives having improved reaction efficiencies wherein the starch and anhydride reagent are predispersed or intimately contacted at low pH before being brought to alkaline reaction conditions. The disclosures of the preparation of the starch derivatives as found in the above noted '349 and '699 patents are hereby incorporated by reference. Other disclosures of the starch derivatives and the method of preparation can be found in “Starch: Chemistry and Technology”, second edition, edited by R. L. Whistler et al., 1988, pp. 341-343 and “Modified Starches: Properties and Uses”, edited by O. Wurzburg, 1986, Chapter 9, pp. 131-147.

Polyvinyl alcohol is a well known, commercially available product prepared by the hydrolysis of polyvinyl acetate and is characterized by the degree of hydrolysis, i.e. 95% hydrolyzed represents 95% OH (hydroxyl) groups and 5% remaining acetate groups. It is typically available in grades defined as partially hydrolyzed to fully or super hydrolyzed and having a degree of hydrolysis of from about 88 to 99%. The polyvinyl alcohol component used in this invention is partially to fully hydrolyzed and has a degree of hydrolysis of 88 to 99%. The preferred polyvinyl alcohol has a degree of hydrolysis of from about 95 to 99%. The viscosity of the polyvinyl alcohol will vary with the molecular weight, and is measured in centipoise of a 4% aqueous solution at 20° C. The useful viscosity range is from about 2 to 50 and preferably in the higher range of about 25 to 50 centipoise. This higher range typically relates to a weight average molecular weight of about 130,000 to 180,000 grams per mole. The amount of polyvinyl alcohol used in the composition of this invention will be from about 1 to 10% and preferably about 2 to 5% by weight, based on the weight of dry starch.

The modified starch has to be fully dispersed in water before use or application. Typically, the starch will be cooked above 100° C. and preferably from about 135 to 150° C. This can be accomplished by jet cooking or extrusion. The starches can either be jet cooked or predispersed by other means known in the art such as extrusion, spray drying or coupled jet cooking, spray drying which renders the starch batch cookable. The polyvinyl alcohol can be added before the cooking or dispersion of the starch or can be dissolved in water and added after cooking.

Because of viscosity requirements, the concentration of the formulation in water will be from about 2 to 25%, preferably from about 5 to 15% and more preferably from about 7 to 12% by weight.

The starch coating or size dispersion is applied to a previously prepared paper or paperboard web by means of any conventional coating and surface sizing technique. These techniques include, but are not limited to, size press, tub, gate roll and spray applicators and calender stack sizing procedures with spray and size press being preferred. Thus, for example, in a size press technique, surface sizing is accomplished by passing the web of paper between a pair of press rolls wherein the lower roll of the pair is rotating in a batch of the sizing dispersion. The surface of this roll picks up size and deposits it on the lower surface of the web. If desired, the coating or sizing may also be applied to the upper surface of the web by pumping it into the nip formed between the web and the upper roll, or by spraying it against the surface of the upper roll and allowing it to accumulate on the upper surface of the web as it enters the press. For example, the starch composition can be sprayed by pumping through a nozzle and atomizing and applying it uniformly to the sheet or web. Means of atomizing or misting by mechanical action may also be utilized. The coated or sized webs are then dried by means of any conventional drying operation selected by the practitioner to essentially remove all of the moisture.

The coating and surface size composition of the present invention may be successfully utilized for coating and sizing paper and paperboard prepared from all types of both cellulosic and combinations of cellulosic with non-cellulosic fiber. Also included are sheet-like masses and molded products prepared from combinations of cellulosic and non-cellulosic materials derived from synthetics such as polyamide, polyester and polyacrylic resin fibers as well as from mineral fibers such as asbestos and glass. The hardwood or softwood cellulosic fibers which may be used include bleached and unbleached soda, neutral sulfite, semi-chemical, groundwood, chemi-groundwood, and any combinations of these fibers. In addition, synthetic cellulosic fibers of the viscose rayon or regenerated cellulose type can also be used, as well as recycled waste papers from various sources.

All types of fillers, pigments, dyes and rheology modifiers may be added in the usual manner to the paper product which is to be coated or sized. Such materials include clay, talc, titanium dioxide, calcium carbonate, calcium sulfate and diatomaceous earths. Usually an effective additive amount of up to about 25% by weight can be used.

The starches of this invention are ordinarily employed in amounts to provide a coating or size concentration ranging from about 0.25 to 15.0% by weight, dry basis, and preferably from about 0.5 to 5% by weight based on the weight of the finished dry paper. Within this range, the precise amount which is used will depend for the most part upon the type of pulp which is being utilized, the specific operating conditions, as well as the particular end use for which paper is desired.

The use of the present starches as coatings and surface sizing agents results in paper characterized by improved water resistance, reduced porosity and increased oil resistance.

The following examples further illustrate the embodiments of this invention. In the examples, all parts and percentages are given by weight and all temperatures are in degrees Celsius unless otherwise noted.

### EXAMPLE 1

Jet Cooked Dispersion Process

The starch sample was suspended at a concentration of 15% by weight in cold (20° C.) water. The suspended starch was then dispersed by continuous steam injection jet cooking in which the starch slurry was pumped into a stream of steam in a “cooking chamber” at a pressure of 67 psia and at a temperature of 148° C. The sample was collected and cooled to 65° C. A 21% solution of highly hydrolyzed, high molecular weight polyvinyl alcohol available from Dupont (Elvinol 90-50) was prepared and added to the starch cook providing a 5.6% (dry starch basis) mixture and the final solids adjusted to 10% with water.

Application Process

The dispersed starch composition was applied to paper at a concentration of 10% by weight in water at a temperature of 65° C. using a modified ETM Multiple System Lab Coater, manufactured by Euclid Tool and Machine. The technique of application used is generally known as a metered sized press or film transfer size press, in which a “film” of the starch dispersion is applied to two oppositely rotating rolls. The paper passes between the two rolls where the starch film was then transferred to the base paper substrate. After application the paper was dried in an Omega/Arkay photographic drum drier. Application weight onto the paper was determined by weight difference between the untreated paper and the treated paper. The resulting paper samples were tested for physical properties using the following tests, with the results being shown in Table 1.

Gurley Porosity

Low-Pressure Gurley Density Testing (TAPPI Std. T460 as of Novembe 1992). This test measures the air resistance of paper that permits the passage of 100 cc of air through a paper section covering the orifice of the Gurley Densitometer in 5 to 1800 seconds. The result of this test, when reported as seconds per 100 cc of air per square inch opening, is commonly referred to as Gurley seconds.

Cobb TAPPI t441 om-90

This test is utilized to determine the absorbitivity of paper to various fluids. In this testing, water was replaced with silicone fluid and silicone absorbtion is reported as g/sq. M.

TAPPI UM-557

This test or “The 3M kit” is used to examine the effect of viscosity and polarity on the ability of the treated paper to resist penetration and wicking of oily substances.

Shirlastain Dye Test

This test is used to determine the effectiveness of the starch coating for silicone efficiency. In this test a dye stained area is measured with an imaging system and the results are given as stained area/measured area or % area stained.

TABLE 1
Properties of Coated Paper

| | | Blend | | | Tappi | Shirlastain |
|---|---|---|---|---|---|---|
| | | Ratio | | Silicone | UM-557 | Dye |
| Ex. | Starch | Starch: | Gurley | Cobb | “3M Kit | % Stained |
| # | Formulation | PVOH | Porosity | g./sq. M. | Test” | Area |
| 1 | Hylon VII, | 17:1 | 43000 | 1.07 | 12 | 1.01 |
| | 3% OSA/ | | | | | |
| | PVOH | | | | | |
| 2 | Hylon VII, | 17:1 | 11400 | 1.64 | 7 | not tested |
| | 3% OSA | | | | | |
| 3 | Hydroxy- | 17:1 | 18200 | 1.74 | 5 | 8.6 |
| | ethylated | | | | | |
| | corn/PVOH | | | | | |
| 4 | 70WF Waxy | 17:1 | 7150 | 1.62 | 5 | not tested |
| | Corn, 3% | | | | | |
| | OSA/PVOH | | | | | |
| 5 | Hylon VII, | 17:1 | 9000 | not tested | not tested | not tested |
| | 7% PO/ | | | | | |
| | PVOH | | | | | |
| 6 | Hylon VII, | 17:1 | 9700 | not tested | not tested | not tested |
| | 10% OSA/ | | | | | |
| | PVOH | | | | | |

Formulation notations:
Hylon VII - high amylose corn starch with about 70% amylose content
OSA - octenyl succinic anhydride
PVOH- polyvinyl alcohol
PO - propylene oxide

As can be seen from the results given in Table 1, polyvinyl alcohol provides improvement when added to any base starch, but provides a significant unexpected relationship when used with the hydrophobically modified high amylose starch in accordance with this invention (example # 1).

### EXAMPLE 2

A dry blend containing 95 parts of a 3% octenyl succinic anhydride (OSA) treated Hylon VII (high amylose corn starch with about 70% amylose content, available from National Starch and Chemical Company) and 5 parts of polyvinyl alcohol were suspended at a concentration of 15% by weight in cold (20° C.) water. The suspended starch formulation was then dispersed by continuous steam injection jet cooking in which the starch slurry was pumped into a stream of steam in a “cooking chamber” at a pressure of 67 psia and a temperature of 148° C. The sample was collected and diluted to 10% by weight in water for application. The formulation was then allowed to cool to room temperature (21.5° C.). The dispersed starch was filtered through a 400 micron mesh bag and pumped to a spray nozzle with a 0.4064 millimeter orifice at 200 psig to produce a spray pattern of 105° and a flow rate of approximately 0.112 gallons per minute and applied to paper.

### EXAMPLE 3

A 142.5 g sample of high amylose corn starch (Hylon VII with about 70% amylose content) modified with 3% octenyl succinic anhydride (OSA) was slurried into 850 g of tap water and mixed until uniform. Then 7.5 g of polyvinyl alcohol (Elvinol 90-50) was added to the slurry and mixed for 5 minutes with an overhead stirrer. The slurry was cooked using continuous steam injection jet cooking using the same procedure described in Example 1. The starch cook was then diluted to 10% with water.

Paper was coated with the dispersed starch using the procedure followed in Example 1 and evaluated for resistance to water penetration using TAPPI 530pm-75. Results are given below in Table 2.

TABLE 2

| Sample Formulation | HST (seconds) |
|---|---|
| Hylon VII w/OSA and 5% PVOH | 93.5 |
| Hylon VII w/OSA | 69.4 |
| Fluidity Waxy w/OSA | 25.7 |
| Fluidity Waxy w/OSA and 5% PVOH | 28.5 |

Formulation notations:
Hylon VII - high amylose corn starch with about 70% amylose content
OSA - octenyl succinic anhydride
PVOH - polyvinyl alcohol

As can be seen in the results in Table 2, hydrophobically modified high amylose starch shows a significant improvement in water penetration with the addition of polyvinyl alcohol. The same improvement is not seen with other hydrophobically starches used in conjunction with polyvinyl alcohol.

What is claimed is:

1. A paper coating composition for providing good barrier properties comprising:
a) a hydrophobically modified high amylose starch where the starch has an amylose content of at least 40% by weight and is modified with a hydrocarbon group of 6 to 18 carbon atoms, and
b) from about 1 to 10% by weight, based on the weight of dry starch, of hydrolyzed polyvinyl alcohol having a degree of hydrolysis of from about 88 to 99%.

2. The composition of claim 1 wherein the modified starch has the formula: 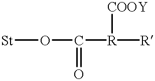
where St is high amylose starch, R is dimethylene or trimethylene, R′ is a hydrocarbon group of 6 to 18 carbon atoms and Y is H, alkali metal, alkaline earth metal or ammonium.

3. The composition of claim 2 wherein f rom about 1 to 5% by weight of the: 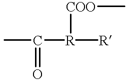
group is bound to the starch, based on the dry weight of the starch.

4. The composition of claim 3 wherein R is dimethylene and R′ is a hydrocarbon of 8 to 12 carbon atoms.

5. The composition of claim 4 wherein the composition is in aqueous solution having a total solids content of from about 2 to 25% by weight.

6. The composition of claim 5 wherein the starch has an amylose content of at least 65%.

7. The composition of claim 5 wherein the polyvinyl alcohol has a degree of hydrolysis of from about 95 to 99%.

8. The composition of claim 5 where R′ is an alkyl or alkenyl group.

9. The composition of claim 8 wherein the starch has an amylose content of at least 65 by weight and the polyvinyl alcohol has a degree of hydrolysis of from about 95 to 99%.

10. The composition of claim 9 which contains about 2 to 3% by weight of the bound group.

11. The composition of claim 4 wherein the composition is in aqueous solution having a total solids content of from about 5 to 15% by weight.

12. The composition of claim 11 wherein the starch has an amylose content of at least 65% by weight and the polyvinyl alcohol has a degree of hydrolysis of from about 95 to 99%.

13. The composition of claim 12 wherein R′ is an alkyl or alkenyl group and the composition contains about 2 to 3% by weight of the bound group.

14. The compositon of claim 4 wherein the composition is in aqueous solution having a total solids content of from about 7 to 12% by weight.

15. A coated paper product having good barrier properties wherein the paper is coated with the composition of claim 1.

16. A coated paper product having good barrier properties wherein the paper is coated with the composition of claim 3.

17. A coated paper product having good barrier properties wherein the paper is coated with the composition of claim 8.

18. A method of preparing a coated paper product having good barrier properties comprising:
a) providing a coating composition comprising the composition of claim 1,
b) applying the coating composition to a paper substrate, and
c) drying the coated substrate to remove moisture and provide the coated paper product.

19. The method of claim 18 wherein the coating composition is applied to the paper substrate by spraying.

20. The method of claim 18 wherein the composition has the formula of claim 2, R is dimethylene and R′ is a hydrocarbon of 8 to 12 carbon atoms.

21. The method of claim 20 wherein the composition is in aqueous solution having a total solids content of from about 2 to 25% by weight.

22. The method of claim 21 wherein the starch has an amylose content of at least 65% by weight, the polyvinyl alcohol has a degree of hydrolysis of from about 95 to 99% and R′ is an alkyl or alkenyl group.
